(19) United States
(12) Patent Application Publication
(10) Pub. No.: US 2019/0018254 A1
(43) Pub. Date: Jan. 17, 2019

(54) Lens Type Display for Displaying Three-Dimensional Images

(71) Applicant: DAYU OPTOELECTRONICS CO., LTD., TAOYUAN CITY (TW)

(72) Inventors: Wen-Sheng Tan, Taoyuan City (TW); Yu-Chieh Chen, Taoyuan City (TW)

(21) Appl. No.: 15/842,864

(22) Filed: Dec. 14, 2017

(30) Foreign Application Priority Data
Jul. 11, 2017 (TW) 106123166

(51) Int. Cl. G02B 27/22; G02B 1/14

(52) U.S. Cl. CPC G02B 27/2214; G02B 1/14; G02B 27/2242

(57) ABSTRACT

A lens type display includes a pixel array and a lens array. The pixel array is used for generating pixel light corresponding to a sub-pixel. The lens array is disposed on the pixel array for refracting the pixel light to a plurality of viewpoints. The lens array includes a plurality of lens packs. Each lens pack includes a curved lens and a prism. Each lens pack is used for refracting the pixel light to three different viewpoints. The three different viewpoints can be three adjacent viewpoints corresponding to a common image.

### BACKGROUND OF THE INVENTION

### 1. Field of the Invention

The present invention illustrates a lens type display, and more particularly, a lens type display for displaying three-dimensional images under a naked eye mode.

### 2. Description of the Prior Art

With advancement of technologies, various display devices are widely adopted in our daily life. Since display technologies improve constantly, requirements of displayed image qualities (i.e., a resolution of displayed images, a color saturation of displayed images) are higher and higher. Further, in addition to the high image resolution and the high color saturation considerations, for a viewer, the display capable of display three-dimensional images becomes an important consideration on the purchase issue.

In general, two display technologies (modes) are introduced for displaying the three-dimensional images. In a first display technology, specific glasses are required to be equipped by a user for viewing the three-dimensional images on the display when a stereoscopic mode is applied to the display. In a second display technology, no additional equipment (i.e., specific glasses) is required for viewing the three-dimensional images when an auto-stereoscopic mode (or say, a naked eye mode) is applied to the display. Particularly, specific glasses can be color filter glasses, polarizing glasses, or shutter glasses.

In the stereoscopic mode, the display provides a left eye image and a right eye image alternatively. The user can see the left eye image and the right eye image individually by using the specific glasses. By using the specific glasses, the user can enjoy a three-dimensional visual experience. In other words, in the stereoscopic mode, a phase delay of an image plane can be introduced for respectively generating a visual image region of a left eye and a visual image region of a right eye in order to provide a three-dimensional color depth effect. However, since the specific glasses are required in the stereoscopic mode for performing the three-dimensional color depth effect of the displayed images, the stereoscopic mode is lack of operation convenience.

In the auto-stereoscopic mode, no additional equipment (i.e., specific glasses) is required for displaying three-dimensional images. An advantage of the auto-stereoscopic mode is to avoid brightness degradation on a display screen. Further, the auto-stereoscopic mode can provide wide viewing zone for displaying the three-dimensional images so that multi-viewers can see the three-dimensional images simultaneously. However, a disadvantage of the auto-stereoscopic mode is prone to generating “Moire Pattern” on the three-dimensional images. Once the “Moire Pattern” is generated, the image quality may be severely decreased.

### SUMMARY OF THE INVENTION

In an embodiment of the present invention, a lens type display is disclosed. The lens type display comprises a pixel array and a lens array. The pixel array comprises a plurality of sub-pixels. Each sub-pixel is configured to generate pixel light.

A lens array is disposed on the pixel array and is configured to refract the pixel light to a plurality of viewpoints. The lens array comprises a plurality of lens packs. Each lens pack comprises a curved lens and a first prism. The curved lens is configured to refract the pixel light to a first viewpoint of the plurality of viewpoints. The first prism is configured to refract the pixel light to a second viewpoint and a third viewpoint of the plurality of viewpoints. The first viewpoint, the second viewpoint, and the third viewpoint are three different viewpoints.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a structure of a lens type display according to the embodiment of the present invention.

FIG. 2 is a structure of a lens array of the lens type display in FIG. 1.

FIG. 3 is an illustration of refracting pixel light from a pixel to different viewpoints through the lens array of the lens type display in FIG. 1.

FIG. 4 is an illustration of blended light at a viewpoint corresponding to several sub-pixels of the lens type display in FIG. 1.

FIG. 5 is a structure of another lens array of the lens type display in FIG. 1.

FIG. 6 is an illustration of refracting pixel light from a pixel to different viewpoints through another lens array of the lens type display in FIG. 1.

FIG. 7 is an illustration of components fabricated by using a first size category in the lens type display in FIG. 1.

FIG. 8 is an illustration of components fabricated by using a second size category in the lens type display in FIG. 1.

FIG. 9 is an illustration of components fabricated by using a third size category in the lens type display in FIG. 1.

### DETAILED DESCRIPTION

FIG. 1 is a structure of a lens type display 100 according to the embodiment of the present invention. The lens type display 100 can be an auto-stereoscopic display for displaying three-dimensional images which are visible for the naked eyes. However, a user can also control the lens type display 100 for displaying two-dimensional images. The lens type display 100 includes a pixel array 14 and a lens array 10. The pixel array 14 includes a plurality of sub-pixels. Each sub-pixel can generate pixel light. The pixel array 14 is a rectangular-shaped pixel array or an oblique pixel array. The pixel light can be emitted from a backlight device through the sub-pixels of pixel array 14. The pixel light can also be generated by a sub-pixel formed by an organic light-emitting diode (OLED) or active-matrix organic light-emitting diode (AMOLED). Any pixel light generation method of the sub-pixel of the pixel array 14 falls into the scope of the present invention. The lens array 10 is disposed above the pixel array 14 for refracting the pixel light to a plurality of viewpoints. The lens array 10 includes a plurality of lens packs. Widths (or say, pitches) of the plurality of lens packs can be identical. Each lens pack corresponds to covering at least two sub-pixels of the pixel array 14. The plurality of lens packs of the lens array 10 are arranged in sequence. Each lens pack includes a curved lens and a first prism. The curved lens is used for refracting the pixel light to a first viewpoint of the plurality of viewpoints. The first prism is used for refracting the pixel light to a second viewpoint and a third viewpoint of the plurality of viewpoints. The first viewpoint, the second viewpoint, and the third viewpoint are three adjacent viewpoints of a common image. In other words, pixel light generated by a sub-pixel of the pixel array 14 can be refracted to three different positions (i.e., viewpoints) by a lens pack (i.e., including a curved lens and a first prism). Here, each lens pack of the lens array 10 can refract the pixel light to several distributed viewpoints. Since each sub-pixel can generate its own pixel light, a light blended effect can be generated by mixing pixel light generated from different sub-pixels. Thus, a ““Moire Pattern”” effect can be mitigated. The lens type display 100 can further include a protection layer 11, an optical-clear-adhesive (OCA) layer 12, and a display plane 13. The protection layer 11 can be formed by polyethylene terephthalate (PET). The OCA layer 12 can be colorless and transparent adhesive with a luminous flux greater than 90%. The OCA layer 12 and the protection layer 11 can be disposed between the lens array 10 and the display plane 13. The display plane 13 is transparent and can be formed by an acrylics material or a glass material. The display plane 13 can be disposed above the pixel array 14.

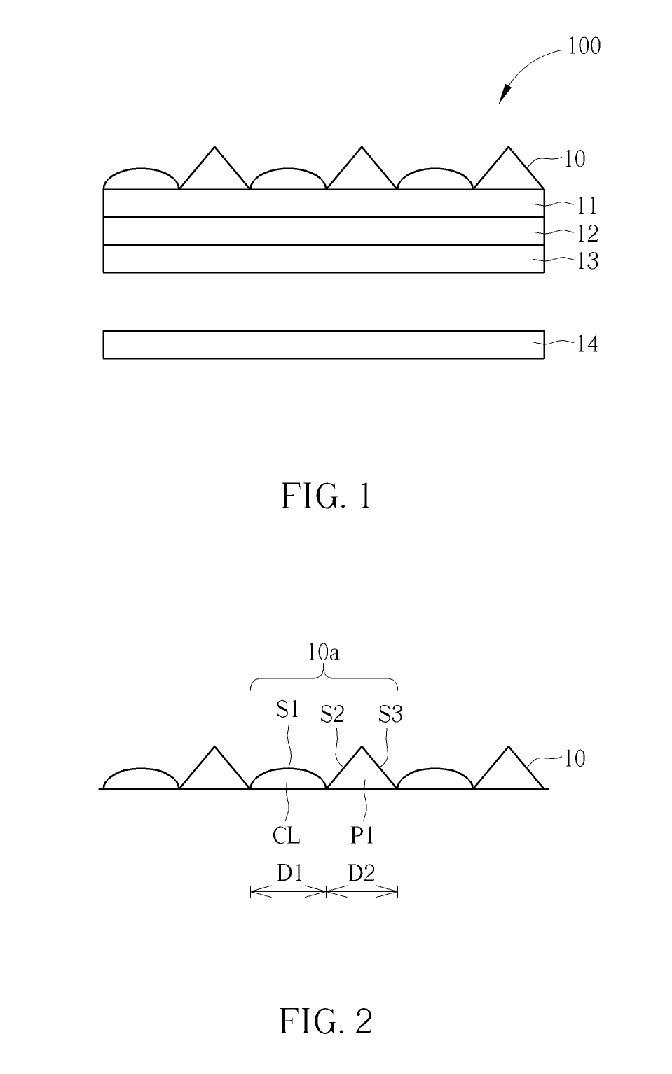

FIG. 2 is a structure of a lens array 10 of the lens type display 100. As previously mentioned, the lens array 10 includes a plurality of lens packs 10a. Each lens pack 10a includes a curved lens CL and a first prism P1. The curved lens CL has a surface S1 with a radius of curvature equal to R. The first prism P1 can be a triangular prism having a base surface and two refraction surfaces. In FIG. 2, a first refraction surface of the first prism P1 is denoted as a surface S2. A second refraction surface of the first prism P1 is denoted as a surface S3. The surface S1 of the curved lens CL can refract the pixel light to a first viewpoint. The surface S2 of the first prism P1 can refract the pixel light to a second viewpoint. The surface S3 of the first prism P1 can refract the pixel light to a third viewpoint. In the first prism P1, the surface S2 and the surface S3 can be two adjoined surfaces with opposite slopes. In other words, an angle can be formed between the surface S2 and the surface S3. In the lens pack 10a, a width of the curved lens CL is equal to D1 (i.e., hereafter say, a first width D1). A width of the first prism P1 is equal to D2 (i.e., hereafter say, a second width D2). Specifically, the first width D1 and the second width D2 can be identical or different. In the lens array 10, widths of all lens packs are identical (i.e., each lens pack width is equal to D1+D2). In the lens type display 100, an index of refraction of each lens pack 10a is greater than an index of refraction of air. Further, each lens pack 10a can be formed by an ultraviolet adhesive material, an acrylics material, a polycarbonate material, a polyethylene terephthalate material, or a liquid crystal material.

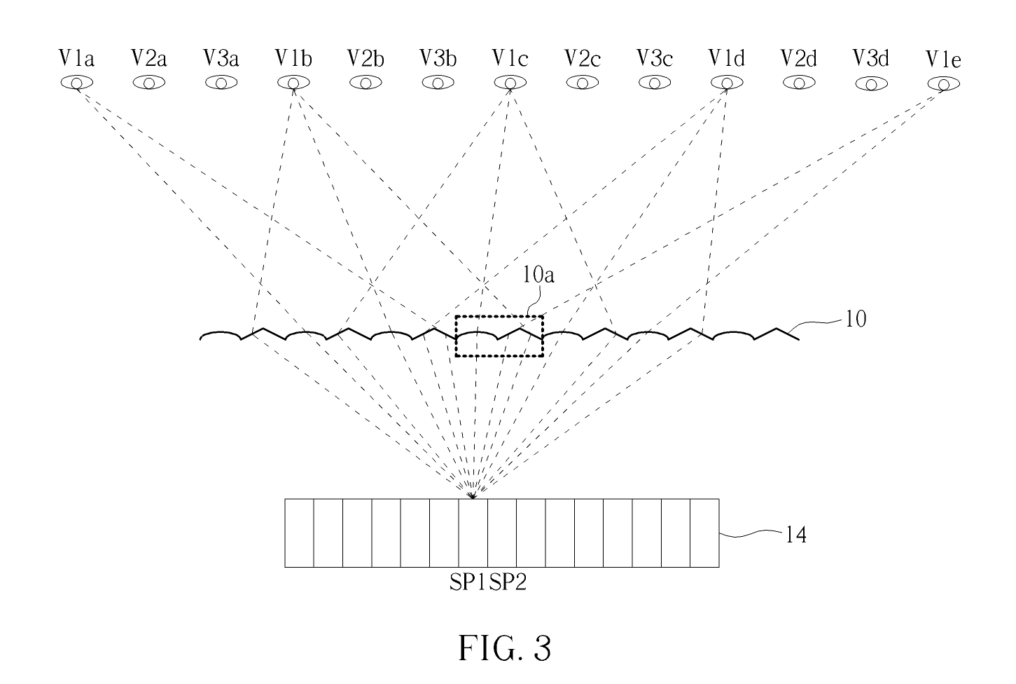

FIG. 3 is an illustration of refracting pixel light from a pixel SP1 to different viewpoints through the lens array 10 of the lens type display 100. For simplicity, optical refraction features of the pixel light generated from the pixel SP1 in the embodiment is introduced in FIG. 3. In FIG. 3, the pixel light generated from the sub-pixel SP1 is refracted to different viewpoints through several lens packs. For example, the pixel light generated from the sub-pixel SP1 is refracted to a viewpoint V1a, a viewpoint V1b, a viewpoint V1c, a viewpoint V1d, and a viewpoint V1e. Particularly, spacing distance between two adjacent viewpoints of the viewpoint V1a, the viewpoint V1b, the viewpoint V1c, the viewpoint V1d, and the viewpoint V1e can be a predetermined constant. For example, when a minimum spacing distance between two adjacent viewpoints of the lens type display 100 is equal to D, a spacing distance between the viewpoint V1a and the viewpoint V1b can be equal to 3*D. A spacing distance between the viewpoint V1b and the viewpoint V1c can be equal to 3*D. A spacing distance between the viewpoint V1c and the viewpoint V1d can be equal to 3*D. A spacing distance between the viewpoint V1d and the viewpoint V1e can be equal to 3*D. In FIG. 3, the surface S1 of the curved lens CL can refract the pixel light generated from the sub-pixel SP1 to the viewpoint V1c. The surface S2 of the first prism P1 can refract the pixel light generated from the sub-pixel SP1 to the viewpoint V1e. The surface S3 of the first prism P1 can refract the pixel light generated from the sub-pixel SP1 to the viewpoint V1b. Thus, the lens pack 10a can refract the pixel light generated from the sub-pixel SP1 to three different viewpoints V1c, V1e, and V1b. In FIG. 3, the pixel light generated from the sub-pixel SP1 can be refracted to five different viewpoints through several lens packs. The sub-pixel SP1 can be a red sub-pixel, a green sub-pixel, or a blue sub-pixel. In the embodiment, each lens pack of the lens array 10 corresponds to covering at least two sub-pixels of the pixel array 14. All lens packs of the lens array 10 are arranged in sequence. Similarly, pixel light generated from a sub-pixel SP2 adjoining the sub-pixel SP1 can also be refracted to five different viewpoints, such as a viewpoint V2a, a viewpoint V2b, a viewpoint V2c, a viewpoint V2d, and a viewpoint V2e (not shown), which can be regarded as a shift version of viewpoints for the sub-pixel SP1. Positions of refracted pixel light of other sub-pixels can also be derived with similar shifting rules previously mentioned.

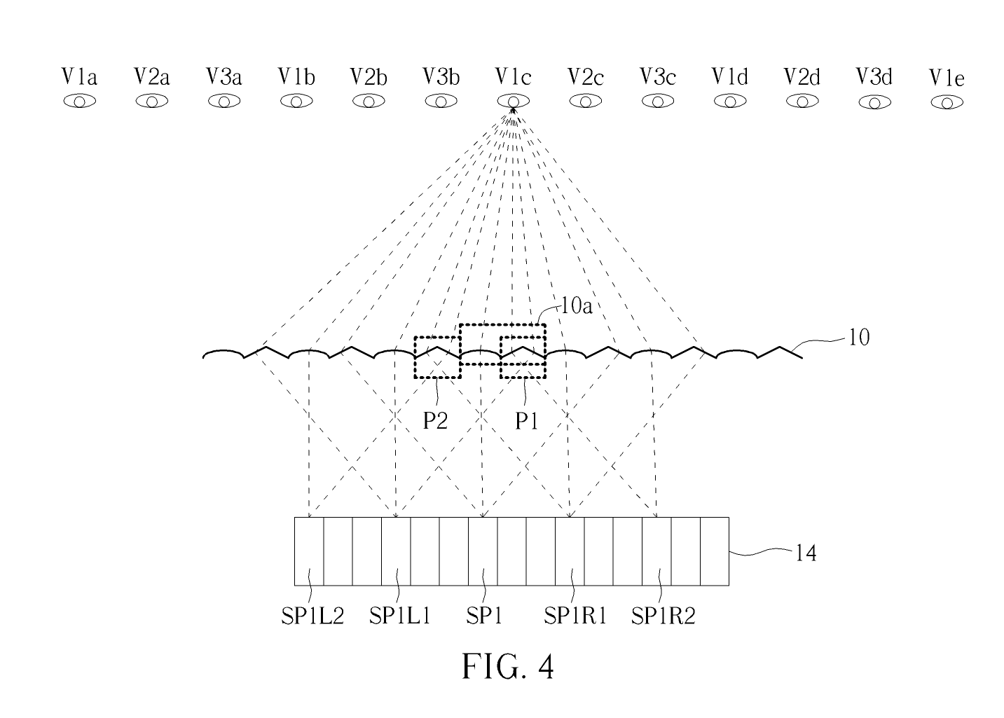

FIG. 4 is an illustration of blended light at a viewpoint V1c corresponding to several sub-pixels of the lens type display 100. FIG. 4 can be regarded as a schematic view of optical paths observed at a single viewpoint V1c. As previously mentioned, pixel light generated from each sub-pixel can be refracted to five different viewpoints through several lens packs. Therefore, for a single viewpoint, blended light can be generated by mixing pixel light transmitted along different optical paths, corresponding to five different sub-pixels. For example, the viewpoint V1c can receive pixel light generated from the sub-pixel SP1, pixel light generated from a sub-pixel SP1R1 (right side) and a sub-pixel SP1L1 (left side), and pixel light generated from a sub-pixel SP1R2 (right side) and a sub-pixel SP1L2 (left side). Particularly, the sub-pixel SP1R1 and the sub-pixel SP1 are separated by one pixel. The sub-pixel SP1L1 and the sub-pixel SP1 are separated by one pixel. The sub-pixel SP1R2 and the sub-pixel SP1 are separated by two pixels. The sub-pixel SP1L2 and the sub-pixel SP1 are separated by two pixels. In other words, in FIG. 4, the first prism P1 can be used for refracting pixel light generated from several sub-pixels to a specific viewpoint. For example, the first prism P1 can be used for refracting pixel light generated from the sub-pixel SP1L1 and the sub-pixel SP1R2 to the viewpoint V1c. For adjacent lens pack, for example, the first prism P2 can be used for refracting pixel light generated from the sub-pixel SP1L2 and the sub-pixel SP1R1 to the viewpoint V1c. However, any reasonable optical refraction design of the first prism P1 falls into the scope of the present invention. In general, the first prism P1 can refract light from two different sub-pixels to a viewpoint. The two different sub-pixels are separated by N pixels. N is a positive integer greater than one. Since the blended light can be generated by receiving and mixing pixel light from different sub-pixels, the Moire pattern effect can be reduced, thereby providing a soft color visual experience to a user. In the embodiment, the viewpoint V1c can receive interleaved (or say, equal spacing gap) sub-pixels. All viewpoints follow similar optical paths to blend pixel light (i.e., shift version). Therefore, the lens type display 100 can provide the soft color visual experience to the user for any viewpoint. Further, since the lens pack 10a is lack of vertical sections, it can avoid a light distortion effect caused by totally reflecting the pixel light in the lens pack 10a many times. In other words, compared with Fresnel lens module, the lens pack 10a of the present invention can avoid the light distortion effect.

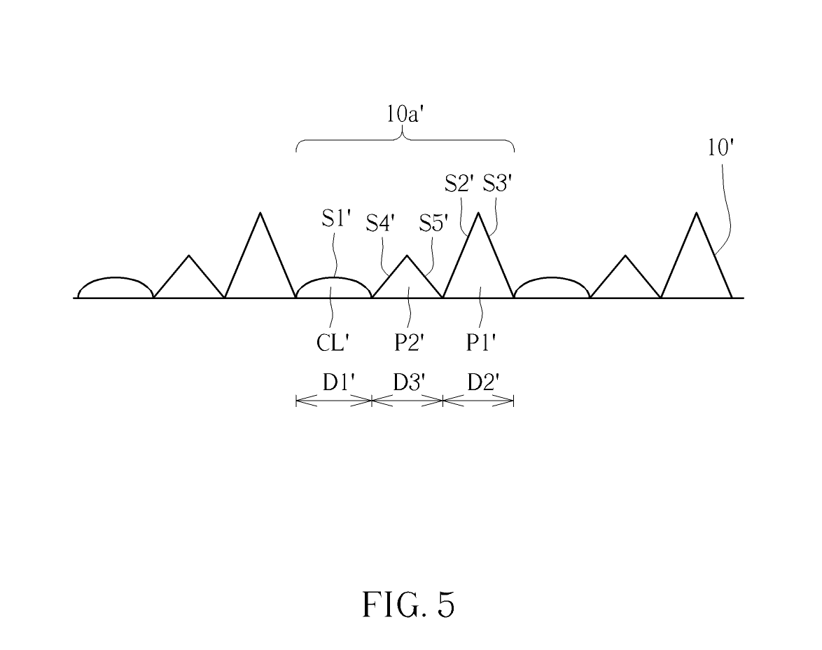

FIG. 5 is a structure of another lens array 10′ of the lens type display 100. Similarly, the lens array 10′ includes a plurality of lens packs 10a′. Each lens pack 10a′ includes a curved lens CL′, a first prism P1′, and a second prism P2′. The curved lens CL′ has a surface S1′ with a radius of curvature equal to R′. The first prism P1′ can be a triangular prism having abase surface and two refraction surfaces. The second prism P2′ can also be a triangular prism having a base surface and two refraction surfaces. In FIG. 5, a first refraction surface of the first prism P1′ is denoted as a surface S2′. A second refraction surface of the first prism P1′ is denoted as a surface S3′. A third refraction surface of the second prism P2′ is denoted as a surface S4′. A fourth refraction surface of the second prism P2′ is denoted as a surface S5′. The surface S1′ of the curved lens CL′ can refract the pixel light to a first viewpoint. The surface S2′ of the first prism P1′ can refract the pixel light to a second viewpoint. The surface S3′ of the first prism P1′ can refract the pixel light to a third viewpoint. The second prism P2′ is disposed between the curved lens CL′ and the first prism P1′. The surface S4′ of the second prism P2′ can refract the pixel light to the first viewpoint. The surface S5′ of the second prism P2′ can refract the pixel light to the fourth viewpoint. In the first prism P1′, the surface S2′ and the surface S3′ can be two adjoined surfaces with opposite slopes. In other words, an angle can be formed between the surface S2′ and the surface S3′. Similarly, in the second prism P2′, the surface S4′ and the surface S5′ can be two adjoined surfaces with opposite slopes. In other words, an angle can be formed between the surface S4′ and the surface S5′. Further, positions of the first prism P1′ and the second prism P2′ are interchangeable. Positions of two surfaces with positive slopes can be exchanged. Positions of two surfaces with negative slopes can be exchanged. For example, the positions of two surfaces S2′ and S4′ with positive slopes can be exchanged. The positions of two surfaces S3′ and S5′ with negative slopes can be exchanged. Here, surfaces with positive slopes and surfaces with negative slopes are alternatively allocated. Any reasonable modification of the lens pack 10a′ falls into the scope of the present invention. In the lens pack 10a, a width of the curved lens CL′ is equal to D1′ (i.e., hereafter say, a first width D1′). A width of the first prism P1′ is equal to D2′ (i.e., hereafter say, a second width D2′). A width of the second prism P2′ is equal to D3′ (i.e., hereafter say, a third width D3′). Further, the first width D1′, the second width D2′, and the third width D3′ are same or not all the same. In the lens type display 100, an index of refraction of each lens pack 10a′ is greater than the index of refraction of air. The each lens pack 10a′ can be formed by an ultraviolet adhesive material, an acrylics material, a polycarbonate material, a polyethylene terephthalate material, or a liquid crystal material.

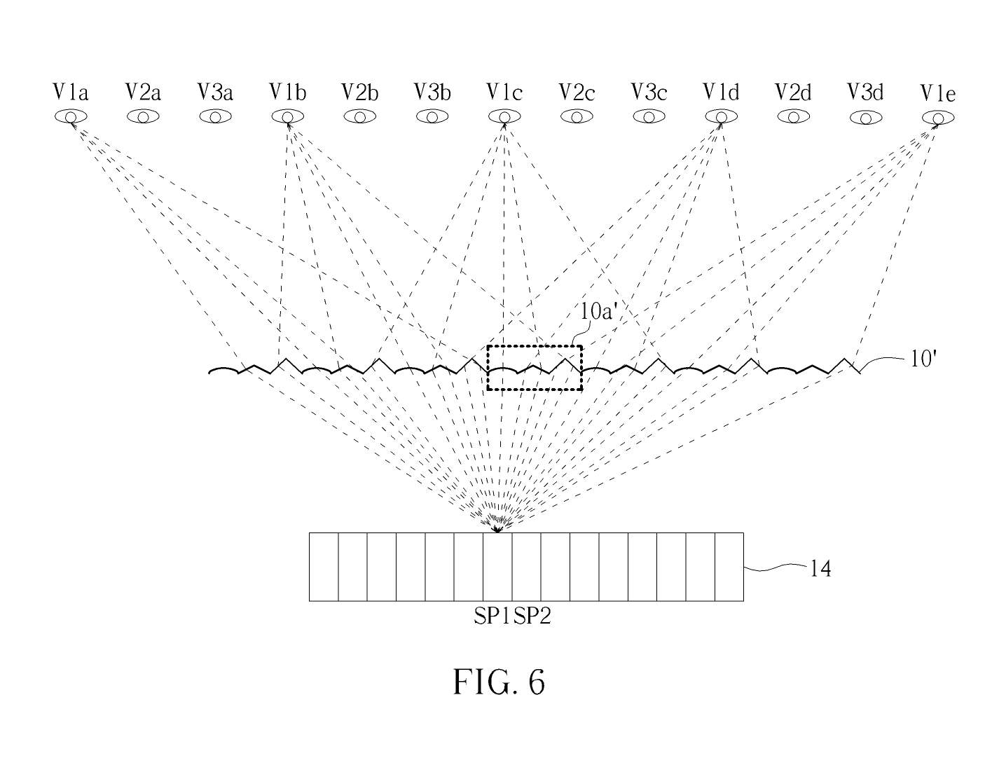

FIG. 6 is an illustration of refracting pixel light from a pixel SP1 to different viewpoints through the lens array 10′ of the lens type display 100. For simplicity, optical refraction features of the pixel light generated from the pixel SP1 in the embodiment is introduced in FIG. 6. In FIG. 6, the pixel light generated from the sub-pixel SP1 is refracted to different viewpoints through several lens packs. For example, the pixel light generated from the sub-pixel SP1 is refracted to a viewpoint V1a, a viewpoint V1b, a viewpoint V1c, a viewpoint V1d, and a viewpoint V1e. Particularly, spacing distance between two adjacent viewpoints of the viewpoint V1a, the viewpoint V1b, the viewpoint V1c, the viewpoint V1d, and the viewpoint V1e can be a predetermined constant. For example, when a minimum spacing distance between two adjacent viewpoints of the lens type display 100 is equal to D, a spacing distance between the viewpoint V1a and the viewpoint V1b can be equal to 3*D. A spacing distance between the viewpoint V1b and the viewpoint V1c can be equal to 3*D. A spacing distance between the viewpoint V1c and the viewpoint V1d can be equal to 3*D. A spacing distance between the viewpoint V1d and the viewpoint V1e can be equal to 3*D. In FIG. 6, the surface S1′ of the curved lens CL′ can refract the pixel light generated from the sub-pixel SP1 to the viewpoint V1c. The surface S2′ of the first prism P1′ can refract the pixel light generated from the sub-pixel SP1 to the viewpoint V1e. The surface S3′ of the first prism P1′ can refract the pixel light generated from the sub-pixel SP1 to the viewpoint V1b. Further, the surface S4′ of the second prism P2′ can refract the pixel light generated from the sub-pixel SP1 to the viewpoint V1d. The surface S5′ of the second prism P2′ can refract the pixel light generated from the sub-pixel SP1 to the viewpoint V1c. Thus, the lens pack 10a′ can refract the pixel light generated from the sub-pixel SP1 to four different viewpoints V1c, V1e, V1b, and V1d. In FIG. 6, the pixel light generated from the sub-pixel SP1 can be refracted to five different viewpoints through several lens packs. The sub-pixel SP1 can be a red sub-pixel, a green sub-pixel, or a blue sub-pixel. In the embodiment, each lens pack of the lens array 10′ corresponds to covering at least two sub-pixels of the pixel array 14. All lens packs of the lens array 10′ are arranged in sequence. Similarly, pixel light generated from a sub-pixel SP2 adjoining the sub-pixel SP1 can also be refracted to five different viewpoints, such as a viewpoint V2a, a viewpoint V2b, a viewpoint V2c, a viewpoint V2d, and a viewpoint V2e (not shown), which can be regarded as a shift version of viewpoints for the sub-pixel SP1. Positions of refracted pixel light of other sub-pixels can also be derived with similar shifting rules previously mentioned. Therefore, similar to FIG. 3 and FIG. 4, the lens array 10′ can be applied to the lens type display 100 for providing the soft color visual experience to a user. Also, since the lens pack 10a′ is lack of vertical sections, it can avoid a light distortion effect caused by totally reflecting the pixel light in the lens pack 10a′ many times. In other words, compared with Fresnel lens module, the lens pack 10a′ of the present invention can avoid the light distortion effect.

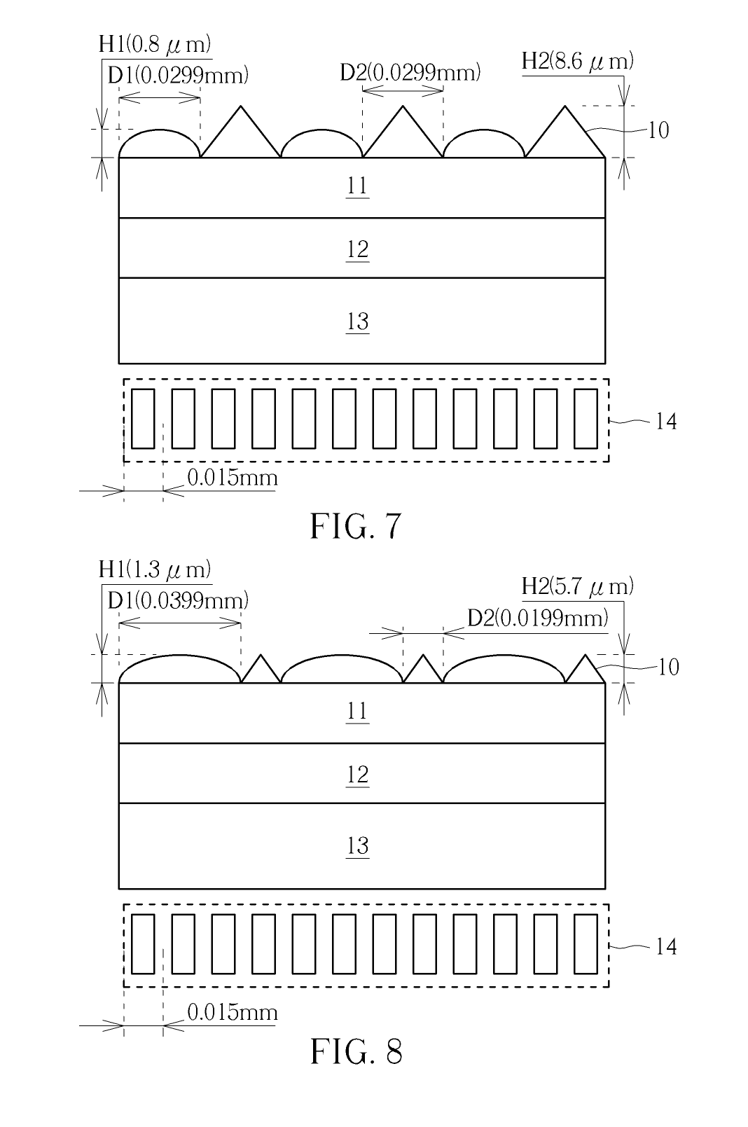

FIG. 7 is an illustration of components fabricated by using a first size category in the lens type display 100. An index of refraction of the lens array 10 is between 1.4 and 1.7. For example, the index of refraction of the lens array 10 can be designed equal to 1.59. A pitch of the each lens pack 10a of the lens array 10 is substantially equal to 0.0598 millimeters. A first width D1 of the curved lens CL is substantially equal to 0.0299 millimeters. A second width D2 of the first prism P1 is substantially equal to 0.0299 millimeters. Further, a radius of curvature R of the curved lens CL is substantially equal to 0.15 millimeters. A first height H1 of the curved lens CL is substantially equal to 0.8 micrometers. A second height H2 of the first prism P1 is substantially equal to 8.6 micrometers. A thickness of the optical clear adhesive layer 12 or the protection layer 11 is substantially equal to 50 micrometers. Additionally, a width of each sub-pixel of the pixel array 14 is substantially equal to 0.015 millimeters. In the lens type display 100 shown in FIG. 7, the first width D1 of the curved lens CL and the second width D2 of the first prism P1 are identical. Thus, the pitch of the each lens pack 10a can be derived as 0.0598=0.0299+0.0299 millimeters. Further, a three-dimensional image sheet can be formed by using the lens array 10, the protection layer 11, and the optical clear adhesive layer 12. In other words, when the three-dimensional image sheet is disposed on the display plane 13, the lens type display 100 can display three-dimensional images with soft color, thereby improving visual experience.

FIG. 8 is an illustration of components fabricated by using a second size category in the lens type display 100. Component allocations in FIG. 8 are similar to component allocations in FIG. 7. In FIG. 8, a first width D1 of the curved lens CL is substantially equal to 0.0399 millimeters. A second width D2 of the first prism P1 is substantially equal to 0.0199 millimeters. Further, a radius of curvature R of the curved lens CL is substantially equal to 0.15 millimeters. A first height H1 of the curved lens CL is substantially equal to 1.3 micrometers. A second height H2 of the first prism P1 is substantially equal to 5.7 micrometers. In the lens type display 100 shown in FIG. 8, the first width D1 of the curved lens CL and the second width D2 of the first prism P1 are different. Thus, the pitch of the each lens pack 10a can be derived as 0.0598=0.0399+0.0199 millimeters. Similarly, a three-dimensional image sheet can be formed by using the lens array 10, the protection layer 11, and the optical clear adhesive layer 12. In other words, when the three-dimensional image sheet is disposed on the display plane 13, the lens type display 100 can display three-dimensional images with soft color, thereby improving visual experience.

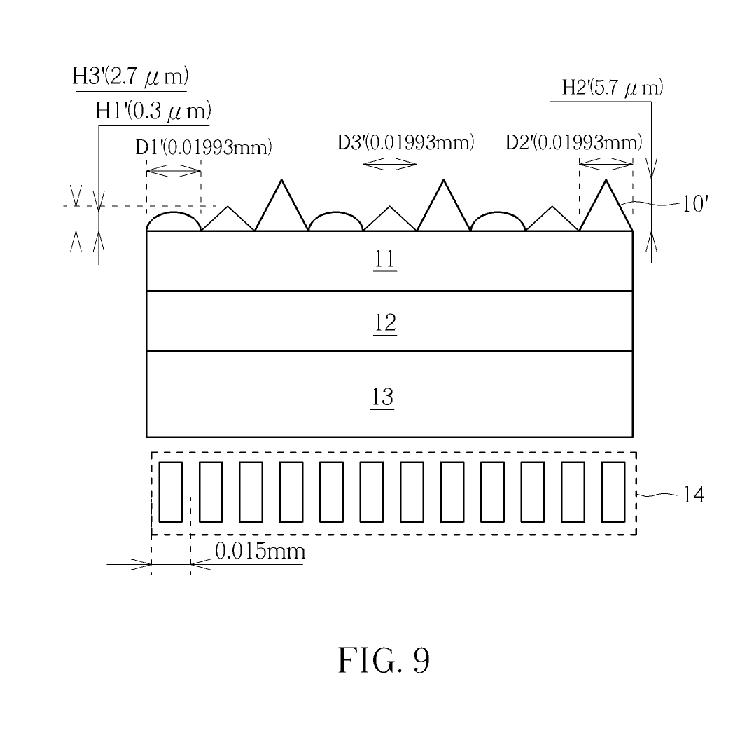

FIG. 9 is an illustration of components fabricated by using a third size category in the lens type display 100. Component allocations in FIG. 9 are similar to component allocations in FIG. 7. Specifically, the lens array 10′ is introduced to the lens type display 100 shown in FIG. 9. Here, a first width D1′ of the curved lens CL′ is substantially equal to 0.01993 millimeters. A second width D2′ of the first prism P1′ is substantially equal to 0.01993 millimeters. A third width D3′ of the second prism P2′ is substantially equal to 0.01993 millimeters. A first height H1′ of the curved lens CL′ is substantially equal to 0.3 micrometers. A second height H2′ of the first prism P1′ is substantially equal to 5.7 micrometers. A third height H3′ of the second prism P2′ is substantially equal to 2.7 micrometers. In the lens type display 100 shown in FIG. 9, the first width D1′ of the curved lens CL′, the second width D2′ of the first prism P1′, and the third width D3′ of the second prism P2′ are identical. Thus, the pitch of the each lens pack 10a′ can be derived as 0.0598 (i.e., 0.0598 is around 0.01993+0.01993+0.01993) millimeters. In FIG. 9, similarly, a three-dimensional image sheet can be formed by using the lens array 10′, the protection layer 11, and the optical clear adhesive layer 12. In other words, when the three-dimensional image sheet is disposed on the display plane 13, the lens type display 100 can display three-dimensional images with soft color, thereby improving visual experience.

In FIG. 7 to FIG. 9, various component size categories are introduced to the lens type display 100. However, the present invention is not limited to using component sizes shown in FIG. 7 to FIG. 9. Any reasonable component size modification falls into the scope of the present invention. For example, component sizes of the lens type display 100 can be proportionally changed. Also, a radius of curvature of the curved lens and a slope of each refraction surface of prism can be customized.

To sum up, the present invention discloses a lens type display capable of blending light from different sub-pixels. The lens type display can perform an auto-stereoscopic mode (or say, naked eye mode) for displaying three-dimensional images. The lens type display includes a specific lens array. The specific lens array can refract pixel light to different viewpoints. Equivalently, for a single viewpoint, a light blended effect can be achieved by mixing some pixel light generated from different sub-pixels. Thus, a ““Moire Pattern”” effect can be mitigated. Thus, the lens type display can display three-dimensional images with soft color, thereby improving visual experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lens type display comprising:
a pixel array comprising a plurality of sub-pixels, each sub-pixel configured to generate pixel light; and
a lens array disposed on the pixel array and configured to refract the pixel light to a plurality of viewpoints, the lens array comprising a plurality of lens packs, each lens pack comprising:
a curved lens configured to refract the pixel light to a first viewpoint of the plurality of viewpoints; and
a first prism configured to refract the pixel light to a second viewpoint and a third viewpoint of the plurality of viewpoints;
wherein the first viewpoint, the second viewpoint, and the third viewpoint are three different viewpoints.

2. The lens type display of claim 1, wherein the three different viewpoints are three adjacent viewpoints of a common image.

3. The lens type display of claim 1, wherein the curved lens of the each lens pack has a radius of curvature, and the first prism comprises:
a first refraction surface configured to refract the pixel light to the second viewpoint; and
a second refraction surface adjoined the first refraction surface and configured to refract the pixel light to the third viewpoint.

4. The lens type display of claim 1, wherein widths of the plurality of lens packs are identical.

5. The lens type display of claim 1, wherein the each lens pack corresponds to at least two sub-pixels of the pixel array, and the plurality of lens packs of the lens array are arranged in sequence.

6. The lens type display of claim 1, wherein the each lens pack further comprises:
a second prism disposed between the curved lens and the first prism, and configured to refract the pixel light to a fourth viewpoint and the first viewpoint of the plurality of viewpoints.

7. The lens type display of claim 6, wherein positions of the first prism and the second prism are changeable.

8. The lens type display of claim 7, wherein the second prism comprises:
a third refraction surface configured to refract the pixel light to the fourth viewpoint; and
a fourth refraction surface adjoined the third refraction surface and configured to refract the pixel light to the first viewpoint.

9. The lens type display of claim 7, wherein the curved lens has a first width, the first prism has a second width, the second prism has a third width, and the first width, the second width, and the third width are identical.

10. The lens type display of claim 7, wherein the curved lens has a first width, the first prism has a second width, the second prism has a third width, and the first width, the second width, and the third width are not all the same.

11. The lens type display of claim 1, wherein an index of refraction of the each lens pack is greater than an index of refraction of air, and the each lens pack is formed by a ultraviolet adhesive material, an acrylics material, a polycarbonate material, a polyethylene terephthalate material, or a liquid crystal material.

12. The lens type display of claim 1, wherein the pixel array is a rectangular-shaped pixel array or an oblique pixel array.

13. The lens type display of claim 1, further comprising:
an optical-clear-adhesive (OCA) layer and a protection layer disposed between the lens array and the pixel array.

14. The lens type display of claim 13, wherein a thickness of the optical clear adhesive layer or the protection layer is substantially equal to 50 micrometers.

15. The lens type display of claim 1, wherein the first prism of the each lens pack refracts light from two different sub-pixels to a viewpoint, the two different sub-pixels are separated by N pixels, and N is a positive integer greater than one.

16. The lens type display of claim 1, wherein an index of refraction of the lens array is between 1.4 and 1.7.

17. The lens type display of claim 1, wherein a pitch of the each lens pack of the lens array is substantially equal to 0.0598 millimeters, a first width of the curved lens is substantially equal to 0.0299 millimeters, and a second width of the first prism is substantially equal to 0.0299 millimeters.

18. The lens type display of claim 17, wherein a radius of curvature of the curved lens is substantially equal to 0.15 millimeters, a first height of the curved lens is substantially equal to 0.8 micrometers, and a second height of the first prism is substantially equal to 8.6 micrometers.

19. The lens type display of claim 1, wherein a pitch of the each lens pack of the lens array is substantially equal to 0.0598 millimeters, a first width of the curved lens is substantially equal to 0.0399 millimeters, and a second width of the first prism is substantially equal to 0.0199 millimeters.

20. The lens type display of claim 19, wherein a radius of curvature of the curved lens is substantially equal to 0.15 millimeters, a first height of the curved lens is substantially equal to 1.3 micrometers, and a second height of the first prism is substantially equal to 5.7 micrometers.
